(19) United States
(12) Patent Application Publication
(10) Pub. No.: US 2006/0031074 A1
(43) Pub. Date: Feb. 9, 2006

(54) Coordinated signal generation apparatus

(76) Inventor: Samuel N. Gasque, Hendersonville, NC (US)

Correspondence Address: GREGORY SMITH & ASSOCIATES, 3900 NEWPARK MALL ROAD, 3RD FLOOR, NEWARK, CA, 94560, US

(21) Appl. No.: 11/196,130

(22) Filed: Aug. 2, 2005

Related U.S. Application Data
(63) Continuation-in-part of application No. 11/182,509, filed on Jul. 15, 2005.
(60) Provisional application No. 60/588,855, filed on Jul. 15, 2004.
(60) Provisional application No. 60/598,291, filed on Aug. 2, 2004.

(51) Int. Cl. G10L 21/06

(52) U.S. Cl. 704/276

(57) ABSTRACT

A portable signal generating apparatus that, when activated, emits a visual or audible signal in coordination with other compatible apparatus in the vicinity that it can detect, and with which it can synchronize to create a coordinated signal effect.

### CROSS REFERENCE TO RELATED APPLICATIONS

This application claims the benefit of the priority date of provisional patent application Ser. No. 60/598,291 filed on Aug. 2, 2004. This application is also a continuation in part application of U.S. patent application Ser. No. 11/182,509 filed Jul. 15, 2005 which further claimed the benefit of priority of U.S. provisional patent application Ser. No. 60/588,855 filed on Jul. 15, 2004. All of these applications are herein incorporated by reference in their entirety.

### FIELD OF THE INVENTION

This invention relates generally to the field of devices as used to generate displays or signals, and more particularly for use by sports fans and booster clubs in support of their teams; and still more particular to a mobile device that communicates with other such devices to generating coordinated or complementary signals.

### BACKGROUND OF THE INVENTION

Part of the experience of sports fans comes from cheers, yells, acclamation and loud noise, and visual displays. There is an unspoken feeling that the louder the clamor the better chance of victory for the team. Sports fans from many generations and many countries show their support for a team by having inanimate replicas of the team's mascot, yelling the sounds made by the mascot animal, and displaying visual banners of their team. This experience is very emotional and enjoyable for the fans. Coordinated displays, whether audible, visual, or otherwise enhance the feeling of a shared experience by sports fans.

Often, fans and booster clubs use noise making devices, such as bells, whistles, horns, drums, and megaphones. Air horns and electric power horns have been used. Such devices have been popular as demonstrated by the quantity of devices that have been purchased over the many years that sporting events have occurred. As is known in the art, electronic sounds have been produced by various products using a variety of technologies such as records, audio tapes, compact discs, and digital signals stored in electronic memory.

The evolution of technology has allowed the continual enhancement of the experience for fans and now there is a need to make the experience more unified and coordinated. Typical preexisting technologies are only able to operate in a minimal way with their surroundings.

What is needed is an inexpensive device that could recognize the presence of other such peer devices and cooperatively interact with other such peer devices. The enhanced, shared experience provides a new level of enjoyment for the user of the device and for the many fans at the sporting event.

### SUMMARY OF THE INVENTION

The present invention includes a hand held apparatus that when activated generate displays or signals. The displays or signals may include sounds, visual effects, tactile effects, and others.

When multiple apparatus are used, the apparatus may coordinate the signals. Such embodiments may include the ability to detect and synchronize in response to a pre-determined timing with other apparatus in the vicinity to create the coordinated signaled. The coordinated signals may generate composite displays called signal events generated by the output of multiple similar apparatus. In some embodiments, the signals may serve the purpose of coordinating activity by users of the apparatus, so that a display results at least partly from actions by the users taken in response to coordinated signals from apparatus of the invention.

For example, an audible display may be generated by having a plurality of apparatus emit the animal call of a team mascot or team song. If the sound is of a team mascot, the sound could be generated simultaneously generated by multiple apparatus as a single loud call, or the apparatus may sound independently to simulate the sound of a pack of animals calling.

In some embodiments, the signal generating apparatus is able to produce an authentic animal sound and in a preferred embodiment, the sound is loud enough to be heard by others in large gatherings. In another aspect of the invention, the signal generating apparatus is also able to produce visual effects that may include at least a single light source and, in alternate embodiments, can including moving light sources such as rotating beacons, flat images, or three dimensional images. In other embodiments apparatus in accord with the invention may generate tactile outputs experienced by the user holding or wearing the apparatus. Such tactile feeling may be a simple vibration, or motion of certain indentations/dimples that can be felt. In still further embodiments, the signal generating apparatus is capable of generating odors. Some odors being, but not limited to pleasing odors (“the sweet smell of victory”) when the team is winning, and noxious odors when the team is losing.

In still another aspect of the invention, the signal generating apparatus is able to identify the presence of other such apparatus in its proximity. For example, when synchronized with other signal generating apparatus, the signal generating apparatus could cooperate to produce a coordinated signal made up of the individual signals from a plurality of apparatus of the invention to create a signal event. For example, when synchronized with other apparatus, the signal generating apparatus could cooperate to produce the sound effect of a pack of animals operating in slightly different times, do a simultaneous sound, or a sound that appeared to be passed between signal generating apparatus.

In some embodiments the invention utilizes a microprocessor controlled RF circuit for synchronization purposes. The signal generating apparatus also may have an adjustable volume control and may comfortably fit in the palm of the operator's hand. In some embodiments the invention operates using a portable battery supply that is able to last throughout a complete game including any overtime activity. In some embodiments the apparatus is housed in a durable and weatherproofed enclosure allowing its protection in event of rain.

In yet another aspect of the invention, the signal generating apparatus could be controlled from a centralized device that would affect the entire venue. The purpose being to deactivate some or all signal generating apparatus when authorities so require, activate some or all signal generating apparatus when deemed appropriate, or act as a synchronization source to coordinate the activities of some or all signal generating apparatus.

The invention includes methods. In one example method for coordinating the actions of a group of people to create a coordinated signal event, the steps include: (a) providing two or more people with a signal generating apparatus capable of emitting one or more signals, and also capable of emitting communications to other signal generating apparatus, (b) having one person activate one of the signal generating apparatus to emit a communication that may be received by other signal generating apparatus, (c) receiving the communication by other signal generating apparatus which each initiating a timing in response to receiving the communication, and (d) emitting at least one signal from each of signal generating apparatus in accord with the timing.

In some embodiments the composite signal from the signal generating apparatus creates a coordinated signal event. In other embodiments, the signals emitted are intended to prompt users to perform one or more actions, for example, physical motions or a shout or song. Thus the coordinated signal event is created by the actions of the users in response to the signals from the signal generating apparatus.

### BRIEF DESCRIPTION OF THE DRAWINGS

A better understanding of the present invention will be had upon reference to the accompanying drawings in which like numerals refer to like parts in the several views and in which:

FIG. 1 shows an example system components

FIG. 2 shows a block diagram of example sonic sub-system components

FIG. 3 shows a block diagram of example visual sub-system components

FIG. 4 shows a block diagram of example odor sub-system components

FIG. 5 shows a block diagram of example tactile sub-system components

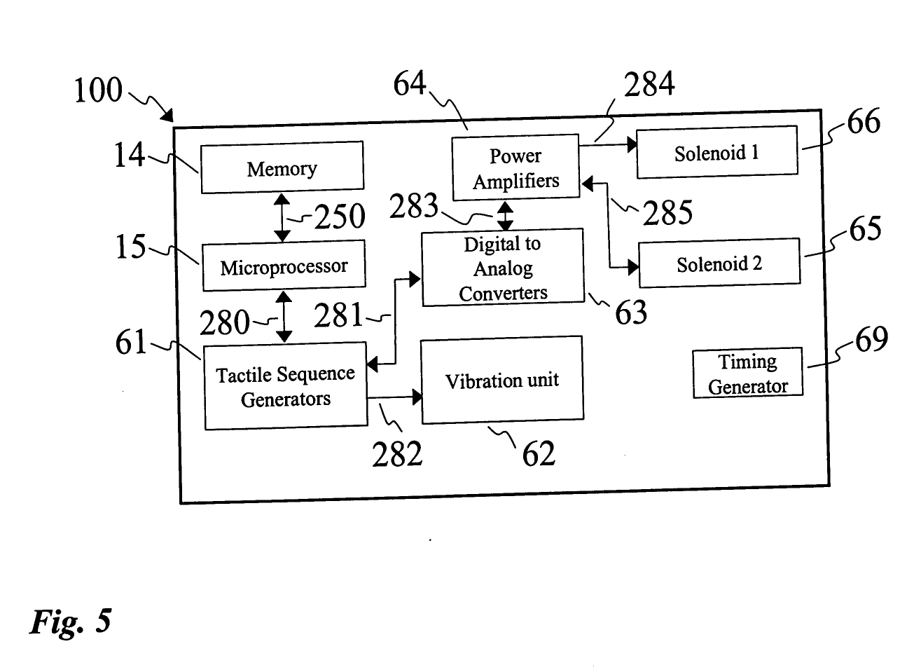

### DETAILED DESCRIPTION

The present invention includes a signal generating apparatus which is a novelty device that is adapted to generate signals and when more than one signal generating apparatus is used, may detect the presence of other such apparatus and be able to participate in generating coordinated displays. Coordinated displays or signals as used herein includes signals from two or more signal generating apparatus including any combination of signal type having a timing and duration that are synchronized or timed to produce a desired signal event effect.

In some embodiments, the signals may serve the purpose of coordinating activity by users of the signal generating apparatus, so that a display results at least partly from actions by the users taken in response to coordinated signals from apparatus of the invention. The displays or signals may include sounds, visual effects, tactile effects, and others.

In some embodiments, the signal generating apparatus is able to produce audible displays preferably loud enough to be heard by others in large gatherings. For example an apparatus of the invention may be adapted to generate an authentic animal sound, for example, the sound or call of a sports team's mascot. When more than one apparatus is used, the apparatus may further be able to synchronize with other apparatus in the local area to create a coordinated sound. For example, the signal generating apparatus may be able mimic a pack of wolves calling at the same time. In still another alternate embodiment, a rival switch may be present on the signal generating apparatus and this mode can be activated by the user. Since the user desires to support his team by the generation of sounds by the signal generating apparatus, the user may also wish to antagonize the opposing team through the use of signal events. When activated, the rival switch would produce a sound that mocked the opposing team. For example, if a rival team has a tiger for its mascot, the mascot would normally produce a loud roaring sound. The signal generating apparatus with the rival switch activated may produce the sound of a mild kitten.

In another example embodiment, the signal generating apparatus is adapted for use by auto racing fans. The signal generating apparatus may emit the sound of particular make of car engine being raced. When more than one signal apparatus is used, the signal apparatus may detect the presence of other such apparatus and be able to participate in generating coordinated audible displays of racing sounds of a particular make of engine.

In another aspect of the invention, the signal generating apparatus is also able to produce visual effects that may include at least a single light source and, in alternate embodiments, can including moving light sources such as rotating beacons, flat images, or three dimensional images.

In other embodiments apparatus in accord with the invention may generate tactile outputs experienced by the user holding or wearing the apparatus. Such tactile feeling may be a simple vibration, or motion of certain indentations/dimples that can be felt. In still further embodiments, the apparatus is capable of generating odors. Some odors being, but not limited to pleasing odors (“the sweet smell of victory”) when the team is winning, and noxious odors when the team is losing.

In some embodiment, the signal generated by the signal generating apparatus is used to coordinate a display generated by movement of the users of the sound generating apparatus. For example, a signal may propagate among signal generating apparatus providing a signal to each user of such device that the user should perform a wave motion. The motion of large groups of fans may be choreographed in this way.

Embodiments of the invention discussed in detail below are provided as examples meant to be used generally in sports environments. Alternate embodiments include, but not limited to, applications in hunting, exercising, zoos, wildlife, toys for children, and law enforcement uses.

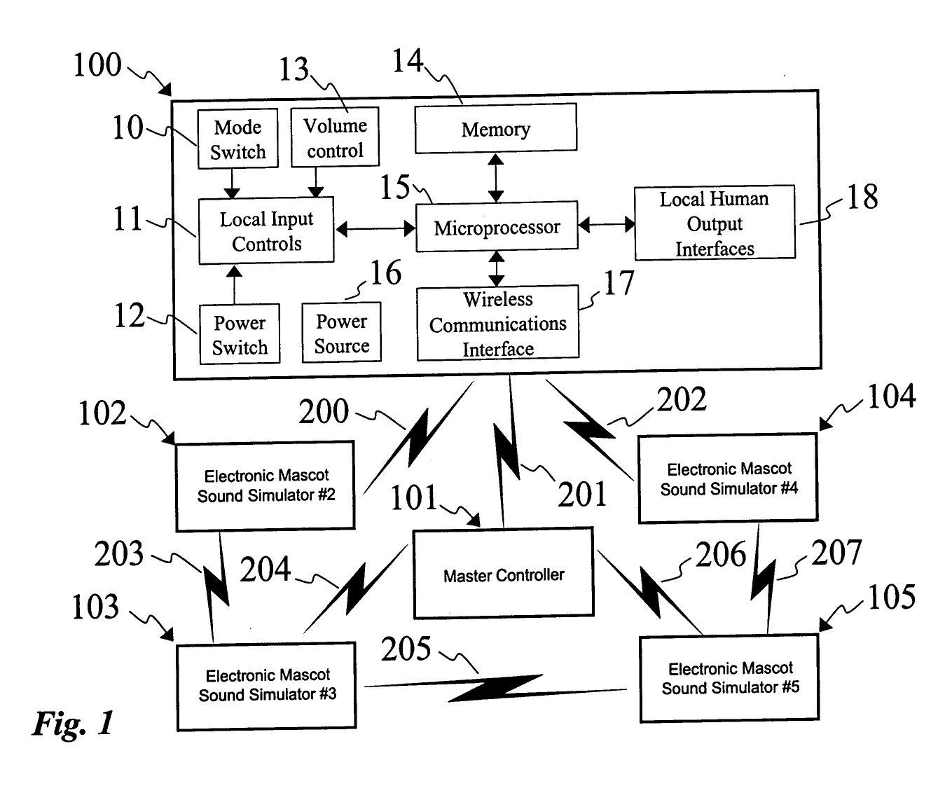

Internal workings of the signal generating apparatus may include but is not limited to electronic circuitry including printed circuit boards, silicon chip devices, and electro-mechanical devices. Referring to FIG. 1, the general components of a system of the present invention are signal generating apparatus 100 and at least one compatible signal generating apparatus 102 and optionally a plurality of signal generating apparatus including 103, 104, and 105. There may be an optional master controller 101 present. signal generating apparatus 100 and signal generating apparatus 102 are able to wirelessly identify the presence of the other apparatus 102.

In an alternate embodiment, the master controller 101 is present at the sports venue and this controller allows event supervisors the ability to enable, disable, synchronize, or selectively control all such signal generating apparatus. Although there is no requirement for a master controller to be present to make use of the present invention, the added features enabled by the controller add useful functionality to the system. There may be times that event supervisors wish to have silence at the venue such as during the national anthem. The master controller would disable all such signal generating apparatus and prevent an audio disturbance.

The wireless technology used for the identification or other signal generating apparatus in the vicinity may be, but not limited to, sonic, Radio Frequency (RF), or infrared (IR) technologies. In the preferred embodiment the wireless technology allows for bi-directional communication between the apparatus. In an alternate embodiment, uni-directional communication is used. Examples of useable wireless technologies include but are not limited to a form of IEEE 802.11 332, a form of Bluetooth 336, a form of IEEE 802.15 338, and a form of IEEE 802.16 334.

The operation of an example embodiment of the invention is as follows. A person wishing to express their exuberance for their team may activate a function on signal generating apparatus 100 which would create a sound signal such a wolf howling.

Signal generating apparatus 100 would contemporaneously send a communication on communications path 200 indicating its activation. In a preferred mode, signal generating apparatus 102 would recognize the communication sent wirelessly from signal generating apparatus 100 and also activate its sound signal. The communication would continue to be relayed in kind to signal generating apparatus 103, 104, and 105. Thus, all the signal generating apparatus would be creating compatible sound signals which together create the desired signal event. In a second preferred mode, signal generating apparatus 102, 103, 04, and 105 may vary the starting of their sound events so that effect generated may be that of several individual wolves starting and stopping at differing times and producing slightly different sounds. Any useable methods for synchronizing the signal events may be used in the invention. For example, when it is desired to initiate a single simultaneous sound event from sound generating apparatus 100, and 102-105, one method for synchronizing the sound events may include transmitting a signal from signal generating apparatus 100 that is received by signal generating apparatus' 102-105, which causes all of the signal generating apparatus' 100 and 102-105 to begin a sound event at the same time.

In an alternate embodiment, the sound event may be enhanced by or replaced by a visual event such as an activation of a light. There is no requirement that all other signal generating apparatuses posses the same capability of generating a sound event, visual event, or both events simultaneously. In one alternate embodiment, a signal generating apparatus may posses neither sound nor visual event capabilities but its presence would allow for the signal generating apparatus to relay trigger messages between signal generating apparatus that do posses such capabilities.

The wireless technology used by master controller 101 to communicate with signal generating apparatus 100 may be, but is not limited to, sonic, Radio Frequency (RF), or infrared (IR) technologies. The communication technology between signal generating apparatus 100 and its peer signal generating apparatus 102 is the same wireless technology as between signal generating apparatus 100 and master controller 101 in the preferred embodiment. In an alternate embodiment, the communication technology between signal generating apparatus 100 and its peer signal generating apparatus 102 is a different wireless technology than is used between signal generating apparatus 100 and master controller 101. In the preferred embodiment the wireless technology from the master controller is uni-directional. In an alternate embodiment, bidirectional communication is used.

In an embodiment where master controller 101 is present, the controller is able to control the activation of the sound and visual events of all the signal generating apparatus at the venue. In an alternate embodiment the controller acts as a coordinator of the sound or visual events occurring in the plurality of signal generating apparatus. Examples of such coordination are, but not limited to, sending a signal that initiates an action that moves progressively through the venue mimicking a “wave” action, having select signal generating apparatus activate to mimic a pack of mascots instead of a single unified mascot, or causing select signal generating apparatus to vary their output events differently from neighboring signal generating apparatus. Similarly, a signal may propagate among signal generating apparatus providing an alert to each user of such device that the user should perform a particular motion. The motion of large groups of fans may be choreographed in this way creating an audible or visual display by the action of large numbers of fans.

The major functional blocks within signal generating apparatus 100 that are required to implement the features of the resent invention are: a local power source 16, microprocessor 15 that manages the output events through block 18 based on the user input received sensed by block 11, and sensing of other external devices through messages being passed through the wireless communications interface 17. The sequence of instructions for the microprocessor are stored in memory 14. A preferred embodiment has the functional blocks housed in a portable, durable enclosure that is weatherproofed allowing its protection in event of rain.

Power source 16 in the preferred embodiment is a primary cell battery that is replaceable when the energy in the cell is exhausted. In an alternate embodiment, a rechargeable battery is present that is designed to last for at least the duration of the sporting event including the additional time when the event goes into single or multiple overtime periods. In still other embodiments, a fuel cell may be used. In yet other embodiments, the local power can be, but not limited to, being received from solar power, RF signals, magnetic signals, optical signals, or any combination of the power sources.

The wireless communications interface 17 may be implemented in a variety of technologies and the usage of any such technology is intended to be within the scope of the presents invention. In the preferred embodiment, signal generating apparatus 100 uses a Radio Frequency (RF) technology communicate with other similar devices and the same RF technology also communicates between signal generating apparatus 100 and master controller 101. Alternate wireless technologies include, but not limited to, sonic, ultrasonic, infrared, magnetic, or visible light technologies. In still other alternate embodiments, the wireless technology between signal generating apparatus 100 and other similar units is not the same as the wireless technology between signal generating apparatus 100 and master controller 101.

The local human output interface 18 consists of an optical output, sonic or sound output or both a sound and optical output that can be sensed by a person. In an alternate embodiment where signal generating apparatus 100 acts as a relay device for wireless messages, block 18 may optionally be present. Control of these output interface technologies is available to the microprocessor through block 11 that connects to settings that may be altered by the user and/or master controller 101. Examples of such settings are, but not limited to, a volume control, the type of output event, the sequencing of the output event, or some modes of operation.

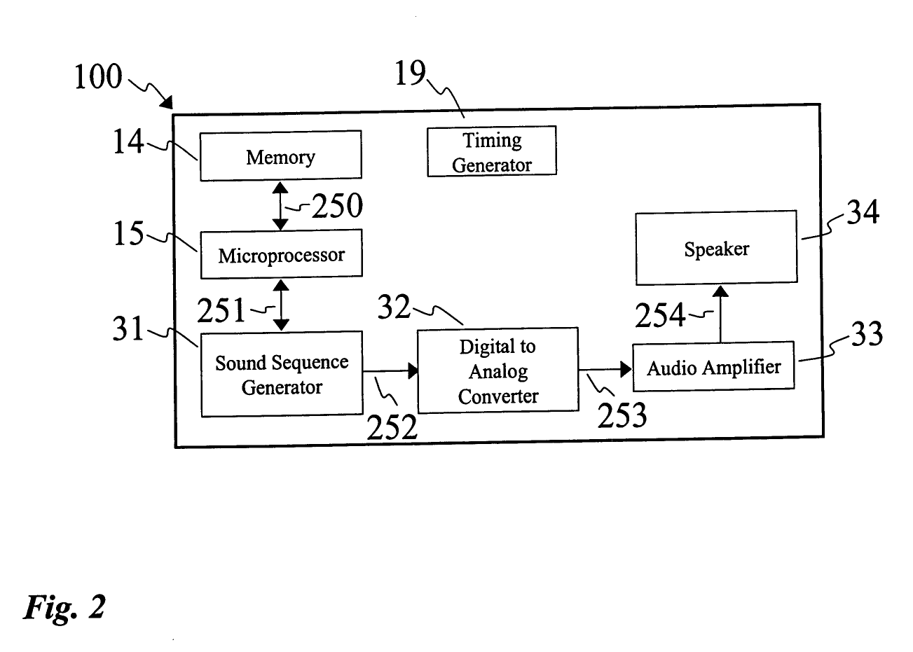

The schematic of the sonic or sound portion of the local human output interface 18 is shown with more detail in FIG. 2. There is an electronic sound sequence generator 31 that is able to create an electronic waveform connected to digital-to-analog converter 32, and sent to amplifier 33 that is able to drive speaker 34. Many suitable or useable technologies and methods are known for use in block 31 to implement its function. Any suitable technology or method is intended to be within the scope of the present invention. The electronic waveform can be generated with sequences initiated over the communications path 251 by microprocessor 15 upon reading memory 14 over communications pathway 250 in the preferred embodiment. In alternate embodiments, the waveform is generated through information within block 31, or in yet another alternate embodiment, information received from the wireless interface.

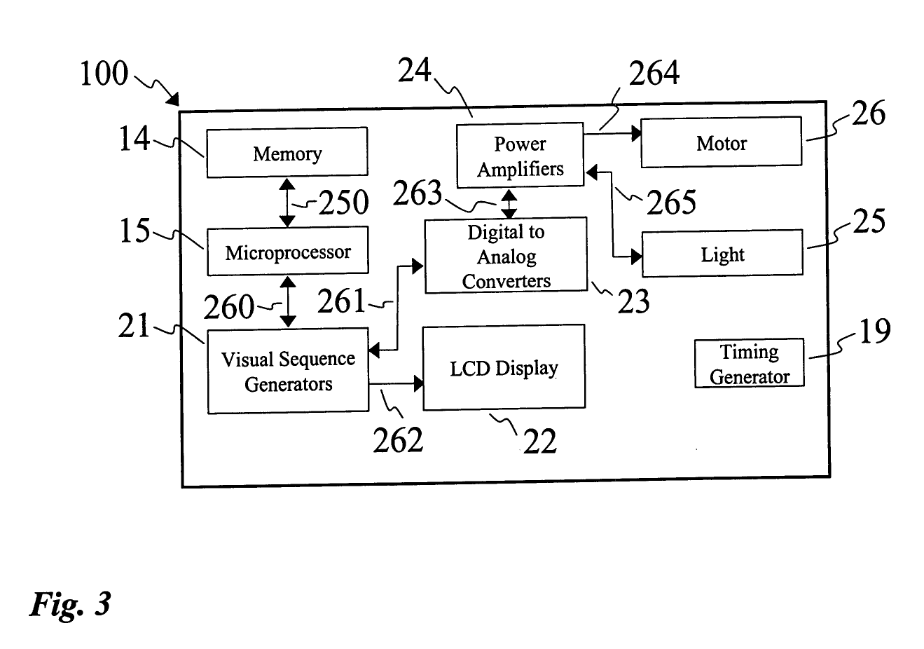

The schematic of the visual portion of the human output interface 18 is shown with more detail in FIG. 3. There is an electronic visual sequence generator 21 that is able to create an electronic waveform connected to digital-to-analog converters 23, and sent to amplifiers 24 that are able to light 25. In an alternate embodiment, motor 26 under the control of visual sequence generator 21, is mechanically adapted to drive light 25 to alter the visual effect. In yet another alternate embodiment, Micro Electro-Mechanical Systems (MEMS) may integrate the visual and mechanical blocks functions. In yet still other alternate embodiments, a more complex, visual image is available for the enjoyment of the users by viewing LCD display 22. Display 22 is under the control of block 21 via communications path 262.

Many suitable or useable technologies and methods are known for use in block 21 to implement its function. Any suitable technology or method is intended to be within the scope of the present invention. The electronic waveform can be generated with sequences initiated over the communications path 260 by microprocessor 15 upon reading memory 14 over communications pathway 250 in the preferred embodiment. In alternate embodiments, the waveform is generated through information within block 21, or in yet another alternate embodiment, information received from the wireless interface.

In previous embodiments, sound and light events were the output modes for interaction with people. In an alternate embodiment, the signal generating apparatus is capable of generating odors. Some odors being, but not limited to pleasing odors (the sweet smell of victory) when the team is winning, and noxious odors when the team is losing.

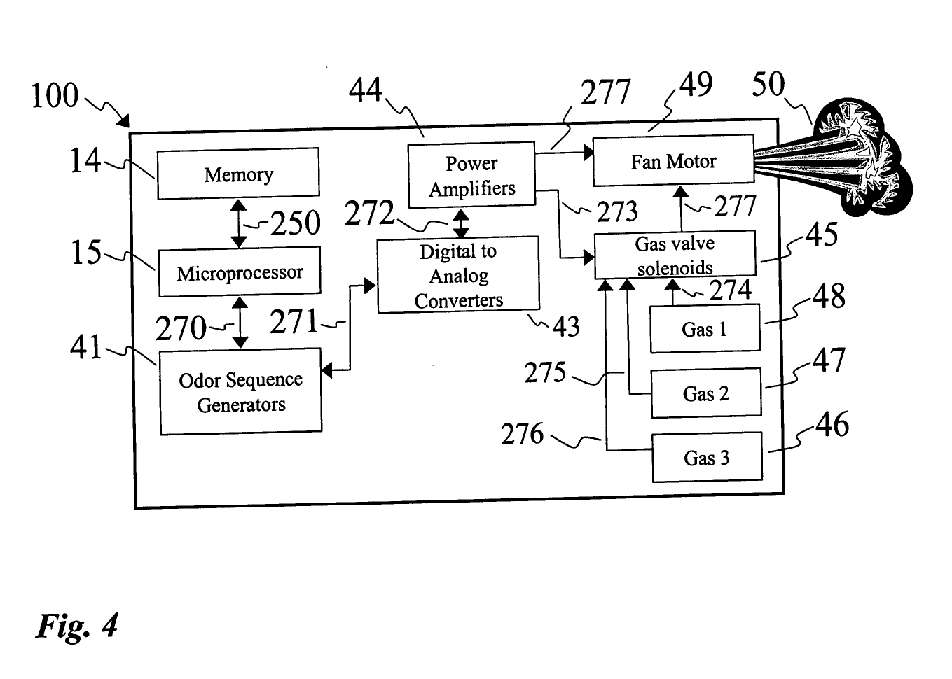

The schematic of the smell portion of the human output interface 18 is shown with more detail in FIG. 4. There is an electronic odor sequence generator 41 that is able to create an electronic waveform that controls the ratios of various gases with different odors. The signal is connected to digital-to-analog converter 43, and sent to amplifiers 44 that is able to drive fan motor 49 and the solenoids that allow the gases to be mixed. Those with ordinary skill in the art will appreciate the variety of methods possible for block 45 to implement its function. The electronic waveform can be generated with sequences initiated over the communications path 271 by microprocessor 15 upon reading memory 14 over communications pathway 270 in the preferred embodiment. In alternate embodiments, the waveform is generated through information within block 41, or in yet another alternate embodiment, information received from the wireless interface. Such odors 50 are detected by the user when emitted from the signal generating apparatus.

In an alternate embodiment, Gas 1 (48), Gas 2 (47) and Gas 3 (46) are replaced by liquid fragrances to be mixed and emitted from the signal generating apparatus. While three canisters of gas are shown in the preferred embodiment, the number of gas or liquid canisters within the signal generating apparatus may change without departing materially from the teachings of the present invention.

In some circumstance, when a user of the signal generating apparatus wants to receive information from other signal generating apparatus or from the Master Controller, audio and visual cues may be difficult to detect. Under these circumstances it may be beneficial for signal generating apparatus to generate a tactile event that can be detected by the user. Such tactile feeling may be a simple vibration, or movement of certain indentations/dimples that can be felt. Through such tactile events, organized actions of groups of signal generating apparatus users can be coordinated.

The schematic of the tactile portion of the Human Output Interface 18 is shown with more detail in FIG. 4. There is an electronic tactile sequence generator 61 that is able to create an electronic waveform that controls the tactile event. The signal is connected to digital-to-analog converter 63, and sent to amplifiers 64 that is able to control the solenoids that allow the user to tactile sense an event. Those with ordinary skill in the art will appreciate the variety of methods possible for block 65 and 66 to implement its function. The electronic waveform can be generated with sequences initiated over the communications path 281 by microprocessor 15 upon reading memory 14 over communications pathway 280 in the preferred embodiment. In alternate embodiments, the waveform is generated through information within block 61, or in yet another alternate embodiment, information received from the wireless interface. Such vibrations are detected by the user when emitted from the signal generating apparatus.

The signal generating apparatus has various modes that trigger one or more of the above mentioned sonic, visual, smell, or tactile events. They can be manually activated, locally synchronized with neighbor units, or controlled from the master controller. Another mode may exists in an alternate embodiment that randomly triggers the signal generating apparatus event. This mode has the unit activate at random without apparent cause and the surprise is deemed by the user to be interesting.

The invention includes methods. In one example method for coordinating the actions of a group of people to create a coordinated signal event, the steps include: (a) providing two or more people with a signal generating apparatus capable of emitting one or more signals, and also capable of emitting communications to other signal generating apparatus, (b) having one person activate one of the signal generating apparatus to emit a communication that may be received by other signal generating apparatus, (c) receiving the communication by other signal generating apparatus which each initiating a timing in response to receiving the communication, and (d) emitting at least one signal from each of signal generating apparatus in accord with the timing.

In some embodiments the composite signal from the signal generating apparatus creates a coordinated signal event. In other embodiments, the signals emitted are intended to prompt users to perform one or more actions, for example, a motion or motions or a shout or song. Thus the coordinated signal event is created by the actions of the users in response to the signals from the signal generating apparatus.

Although exemplary embodiments of the invention have been described in detail above, those skilled in the art will readily appreciate that many additional modifications are possible without departing materially from the teachings and advantages of the invention. For example, the system may be used in hunting where the system can simulate the sounds of a heard of animals to lure an animal into a desired location.

What is claimed is:

1. A system for the generation of a coordinated signal event comprising:
at least two signal generating apparatus capable of emitting at least one signal, each said signal generating apparatus capable of communicating to other said signal generating apparatus, said at least one signal comprises at least one signal type selected from the group consisting of: an audible signal, a visual signal, a tactile signal, and an olfactory signal,
whereby activation of one of said at least two signal generating apparatus causes said one of said at least two signal generating apparatus to emit a communication that may be received by other of said at least two signal generating apparatus, causing said one of said at least two signal generating apparatus and said other of said at least two signal generating apparatus to each activate a timing.
Whereby said one of said at least two signal generating apparatus and said other of said at least two signal generating apparatus each generate a signal in accord with said timing which together comprise a coordinated signal event.

2. The system of claim 1 wherein each said signal generating apparatus includes at least two active states, said at least two active states including an automatic state wherein said signal generating apparatus will respond to communications from other signal generating apparatus to emit said signal as part of said coordinated signal event, and a manual state wherein said signal generating apparatus will respond to communications from other signal generating apparatus to emit said signal as part of said coordinated signal event when said signal generating apparatus is manually activated by a user during a duration of said coordinated signal event.

3. The system of claim 1 further comprising a master communication apparatus.

4. The system of claim 3 wherein each said signal generating apparatus further includes an externally controlled state in which said coordinated signal event may also be initiated by a communication received from said master controller.

5. The system of claim 1 wherein said signal event comprises a sound of an automobile engine.

6. A method for generating a coordinated signal event, the steps comprising:
providing each of at least two people a signal generating apparatus capable of emitting at least one signal, each said signal generating apparatus further capable of emitting a communication to other said signal generating apparatus,
activating one of said signal generating apparatus by one of said at least two people to emit a communication that may be received by other of said signal generating apparatus,
receiving said communication by other of said signal generating apparatus and initiating a timing in response to receiving said communication;
emitting at least one signal from each of said signal generating apparatus in accord with said timing thereby generating a coordinated signal event.

7. The method of claim 6 wherein said at least one signal comprises at least one signal type selected from the group consisting of: an audible signal, a visual signal, a tactile signal, and an olfactory signal.

8. The method of claim 6 wherein each said timing is selected from a plurality of timings

9. The method of claim 6 wherein said at least one signal comprises a first signal and a second signal, and wherein said at least one action comprises a first action and a second action.

10. The method of claim 9 wherein said at least two people perform said first action upon receipt of said first signal, and said second action upon receipt of said second signal.

11. The method of claim 6 wherein activating said one of said signal generating apparatus allows a selection of one of a plurality of timings.

12. The method of claim 6 wherein activating said one of said signal generating apparatus allows a selection of one of a plurality of signals.

13. The method of claim 6 wherein activating said one of said signal generating apparatus allows a selection of one of a plurality of coordinated signal events.

14 A method for coordinating the actions of a group of people to create a coordinated signal event, the steps comprising:
providing to each of a at least two people a signal generating apparatus capable of emitting at least one signal, each said signal generating apparatus capable of emitting a communication to other said signal generating apparatus,
activating one of said signal generating apparatus by one of said at least two people to emit a communication that may be received by other of said signal generating apparatus,
receiving said communication by other of said signal generating apparatus and initiating a timing in response to receiving said communication;
emitting at least one signal from each of said signal generating apparatus in accord with said timing;
performing at least one action by each of said at least two people in response to said at least one signal thereby generating a coordinated signal event.

15. The method of claim 14 wherein said at least one signal comprises at least one signal type selected from the group consisting of: an audible signal, a visual signal, a tactile signal, and an olfactory signal.

16. The method of claim 14 wherein said at least one signal comprises a first signal and a second signal, and wherein said at least one action comprises a first action and a second action.

17. The method of claim 16 wherein said at least two people perform said first action upon receipt of said first signal, and said second action upon receipt of said second signal.

18. The method of claim 14 wherein said action is audible.

19. The method of claim 14 wherein said action is visible.

20. The method of claim 14 wherein said action comprises a motion.
